(19) United States
(12) Patent Application Publication
(10) Pub. No.: US 2025/0148871 A1
(43) Pub. Date: May 8, 2025

(54) PROMO CODE FEATURE

(71) Applicant: IGT, Las VEGAS, NV (US)

(72) Inventors: Nick Hillstrom, Otis Orchards, WA (US); Nathan Ajhar, Sparks, NV (US); Lauren Hillstrom, Otis Orchards, WA (US); Yu Chong, Reno, NV (US)

(21) Appl. No.: 18/387,294

(22) Filed: Nov. 6, 2023

(51) Int. Cl. G07F 17/32

(52) U.S. Cl. CPC G07F 17/3255; G07F 17/3237; G07F 17/3267

(57) ABSTRACT

Embodiments of the present disclosure are directed to promoting electronic games in a gaming environment. Generally speaking, embodiments provide for awarding a token to a player based on game play in a first electronic game, e.g., based on an amount of time played, amount of wagers placed, etc. The token can then be redeemed by the player in a second, promoted electronic game, e.g., for a credit, bonus, and/or other enhancements or benefits. The token can be transferred to and/or from the player via a printed ticket, an electronic token transferred to the players mobile device, or by updating an electronic record associated with the player, e.g., a player's account, etc.

### BACKGROUND

The present disclosure is generally directed to promoting electronic games in a gaming environment and more particularly to awarding a token based on game play in a first electronic game which is redeemable in a second, promoted electronic game.

Development of new electronic games or new versions of electronic games requires investment of human and other resources that the game developer seeks to recover and eventual profit from. However, players of electronic games often have their preferred games that they routinely play. This habit may limit exposure and adoption of new games or game versions. Hence, there is a need in the art for ways to promote games such as new games or game versions, for example, through other games.

### BRIEF SUMMARY

Embodiments of the present disclose are directed to promoting electronic games in a gaming environment. According to one embodiment, a method for operating an electronic game can comprise executing a first electronic game on a first gaming system, monitoring game play information related to the execution of the first electronic game, detecting a termination of the first electronic game on the first gaming system, and generating a token based on the monitored game play information related to execution of the first electronic game. The token can indicate a prize redeemable in a second electronic game. For example, the prize redeemable in the second electronic game can be determined based on an amount of time the first electronic game was played, an amount of wagers made in the first electronic game, etc. The generated token can then be provided to a player of the first electronic game. Providing the generated token to the player of the first electronic game can comprise printing a ticket, updating an electronic record associated with the player of the first electronic game, transferring the token to a mobile device of the player of the first electronic game, etc. The method can further comprise presenting an indication of token acceptance in a second electronic game available on a second gaming system, initiating the second electronic game on the second gaming system, receiving the token provided to the player of the first electronic game, determining the prize indicated by the received token, and redeeming the determined prize in the second electronic game.

According to another embodiment, a system can comprise a first gaming system comprising a processor and a memory coupled with and readable by the processor and having stored therein a set of instructions which, when executed by the processor, causes the processor to execute a first electronic game on the first gaming system, monitor game play information related to the execution of the first electronic game, detect a termination of the first electronic game on the first gaming system, generate a token based on the monitored game play information related to execution of the first electronic game, the token indicating a prize redeemable in a second electronic game, and provide the generated token to a player of the first electronic game. The system can further comprise a second gaming system comprising a processor and a memory coupled with and readable by the processor and having stored therein a set of instructions which, when executed by the processor, causes the processor to present an indication of token acceptance in a second electronic game available on the second gaming system. For example, presenting the indication of token acceptance in the second electronic game available on the second gaming system can comprise displaying, on a display device of the second gaming system, a promo code bug.

The instructions can further cause the processor of the second gaming system to initiate the second electronic game on the second gaming system and receive the token provided to the player of the first electronic game. Receiving the token provided to the player of the first electronic game can comprise reading a ticket, reading an electronic record associated with the player of the first electronic game, or receiving the token from a mobile device of the player of the first electronic game. The instructions can further cause the processor of the second gaming system to determine the prize indicated by the received token and redeem the determined prize in the second electronic game. For example, the determined prize in the second electronic game can be based on an amount of time the first electronic game was played or an amount of wagers made in the first electronic game.

According to yet another embodiment, a non-transitory, computer-readable medium can comprise a set of instructions stored therein which when executed by a processor, causes the processor to execute a first electronic game on the first gaming system, monitor game play information related to the execution of the first electronic game, detect a termination of the first electronic game on the first gaming system, generate a token based on the monitored game play information related to execution of the first electronic game, the token indicating a prize redeemable in a second electronic game and provide the generated token to a player of the first electronic game. The instructions can further cause the processor to present an indication of token acceptance in a second electronic game available on the second gaming system, initiate the second electronic game on the second gaming system, receive the token provided to the player of the first electronic game, determine the prize indicated by the received token, and redeem the determined prize in the second electronic game. The redeemed prize in the second electronic game can comprise a credit, a bonus, a session boost, a discount on wagers, etc.

Additional features and advantages are described herein and will be apparent from the following Description and the figures.

### BRIEF DESCRIPTION OF THE SEVERAL VIEWS OF THE DRAWINGS

FIG. 1 is a diagram illustrating an exemplary gaming environment in which embodiments of the present disclosure my be implemented.

FIG. 2 is a block diagram illustrating additional details of an exemplary first gaming system according to one embodiment of the present disclosure.

FIG. 3 is a block diagram illustrating additional details of an exemplary second gaming system according to one embodiment of the present disclosure.

FIG. 4 is a flowchart illustrating an exemplary process for operating an electronic game according to one embodiment of the present disclosure.

FIG. 5 is a flowchart illustrating an exemplary process for operating an electronic game according to another embodiment of the present disclosure.

### DETAILED DESCRIPTION

Embodiments of the present disclosure are directed to promoting electronic games in a gaming environment. Generally speaking, embodiments provide for awarding a token to a player based on game play in a first electronic game, e.g., based on an amount of time played, amount of wagers placed, etc. The token can then be redeemed by the player in a second, promoted electronic game, e.g., for a credit, bonus, and/or other enhancements or benefits. The token can be transferred to and/or from the player via a printed ticket, an electronic token transferred to the players mobile device, or by updating an electronic record associated with the player, e.g., a player's account, etc.

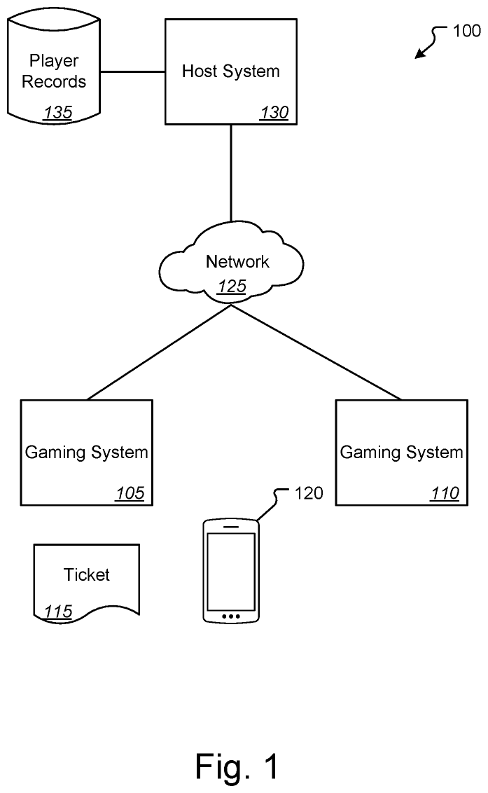

FIG. 1 is a diagram illustrating an exemplary gaming environment in which embodiments of the present disclosure my be implemented. As illustrated in this example, the environment 100 can comprise a first gaming system 105 and a second gaming system 110. The gaming systems 105 and 110 can comprise Electronic Gaming Machines (EGMs), gaming kiosks, and/or other systems as known in the art and which can execute any of a wide variety of electronic games of chance including, but not limited to, slots, video slots, video poker, keno, blackjack, etc. to be played by a player, e.g., in a casino or other gaming venue. Embodiments of the present disclosure provide for promotion of an electronic game executed by one of the gaming systems 110 through an electronic game executed by another of the gaming systems 105. For example, eligible games can be identified by a “bug,” e.g., an icon, or other indicator on a display of the gaming systems 105 and 110. When a player plays one of these games, e.g., on a first gaming system 105, the player can be award a token based on game play of that first electronic game. The token can be awarded, for example, based on an amount of time played, an amount of wagers made, etc. in the first electronic game on the first gaming system 105.

The generated token can then be provided to the player in various ways. For example, the first gaming system 105 can print a ticket 115 containing a QR code or other indicator of the token. In another example, the first gaming system 105 can transmit a QR or other code or other electronic representation of the token to a mobile device 120 of the player. In some cases, the gaming system 105 can be coupled with a communications network 125 and host system 130. The communications network 125 can comprise any one or more wired and/or wireless, local-area and/or wide-area networks as known in the art including, but not limited to, the Internet. The host system 130 can comprise any one or more servers and/or other computing devices as known in the art and which can maintain a set of player records 135 related to a player account for the player. In such cases, the gaming system 105 may transmit a message or other indication of the token to the host system 130 over the communications network 125. The host system 130 can then update the player record 135 to indicate the token.

When the player initiates a second, promoted electronic game on the second gaming system 110, the gaming system 110 can receive the token, e.g., by reading the ticket 115, receiving the token from the player's mobile device 120, or requesting and reading information from the player record 135, via the host system 130. The second gaming system 110 can then redeem the prize represented by the token in the second electronic game. Redeeming prize in the second electronic game can comprise applying a credit, a bonus, a session boost, a discount on wagers, etc. in the second electronic game.

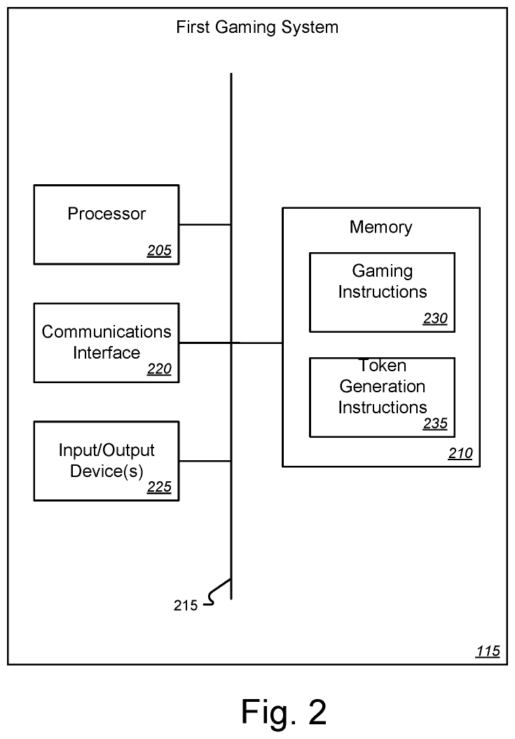

FIG. 2 is a block diagram illustrating additional details of an exemplary first gaming system according to one embodiment of the present disclosure. As illustrated in this example, a gaming system, such as the first gaming system 105 described above, can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 220 and one or more input/output devices 225 via the communications bus 215. The communication interfaces 215 can comprise, for example, a Bluetooth, WiFi, cellular, and/or other type of wireless communications interface. The input/output devices can include, but are not limited to a display device such as a Liquid Crystal Display (LCD), Light Emitting Diode (LED), Organic Light Emitting Diode (OLED), or other type of display, a ticket printer, etc.

The memory 210 can store therein a set of gaming instructions 230 which, when executed by the processor 205, cause the processor 205 to execute an electronic game. The memory 210 can also store therein a set of token generation instructions 235 which, when executed by the processor 205, causes the processor 205 to monitor game play information related to the execution of the first electronic game, detect a termination of the first electronic game on the first gaming system 105, and generate a token based on the monitored game play information related to execution of the first electronic game. The token can indicate a prize redeemable in a second electronic game. For example, the prize redeemable in the second electronic game can be determined based on an amount of time the first electronic game was played, an amount of wagers made in the first electronic game, etc. The token generation instructions 235 can then cause the processor to provide the generated token to a player of the first electronic game. Providing the generated token to the player of the first electronic game can comprise printing a ticket via a printer or other input/output device 225, updating an electronic record associated with the player of the first electronic game, e.g., via communications interface 220, transferring the token via the communications interface 220 to a mobile device 120 of the player of the first electronic game, etc.

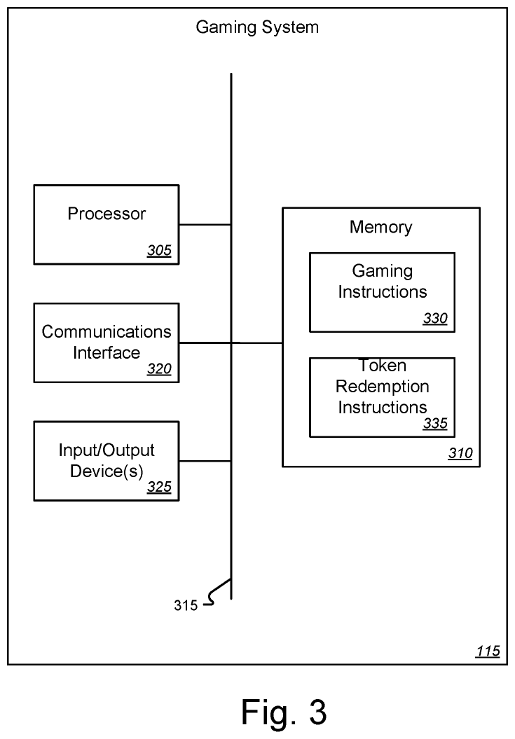

FIG. 3 is a block diagram illustrating additional details of an exemplary second gaming system according to one embodiment of the present disclosure. As illustrated in this example, a gaming system, such as the second gaming system 110 described above, can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 via the communications bus 315. The communication interfaces 320 can comprise, for example, Ethernet, Bluetooth, WiFi, or other type of wired or wireless communications interfaces.

The memory 310 can store therein a set of gaming instructions 225 which, when executed by the processor 205, cause the processor 205 to present an indication of token acceptance, e.g., displaying an icon, message, or other feature on an interface of the second, promoted electronic game and initiate the second electronic game on the second gaming system 110. The memory 310 can also store therein a set of token redemption instructions 335 which, when executed by the processor 305, causes the processor 305 to receive the token provided to the player of the first electronic game. Receiving the token provided to the player of the first electronic game can comprise reading a ticket via a ticket reader or other input/output device 325, reading via the communications interface 320 an electronic record associated with the player of the first electronic game, or receiving the token via the communications interface 320 from a mobile device 120 of the player of the first electronic game. The token redemption instructions 335 can further cause the processor 305 to determine the prize indicated by the received token and redeem the determined prize in the second electronic game. For example, the determined prize in the second electronic game can be based on an amount of time the first electronic game was played or an amount of wagers made in the first electronic game. The redeemed prize in the second electronic game can comprise a credit, a bonus, a session boost, a discount on wagers, etc.

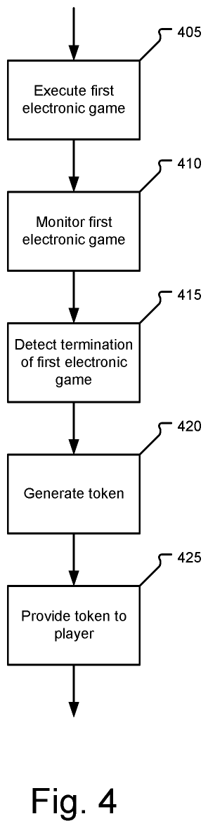

FIG. 4 is a flowchart illustrating an exemplary process for operating an electronic game according to one embodiment of the present disclosure. As illustrated in this example, operating an electronic game can comprise executing 405 a first electronic game on a first gaming system 105, monitoring 410 game play information related to the execution of the first electronic game, detecting 415 a termination of the first electronic game on the first gaming system, and generating 420 a token based on the monitored game play information related to execution of the first electronic game. The token can indicate a prize redeemable in a second electronic game. For example, the prize redeemable in the second electronic game can be determined based on an amount of time the first electronic game was played, an amount of wagers made in the first electronic game, etc. The generated 420 token can then be provided 425 to a player of the first electronic game. Providing 425 the generated token to the player of the first electronic game can comprise printing a ticket, updating an electronic record associated with the player of the first electronic game, transferring the token to a mobile device of the player of the first electronic game, etc.

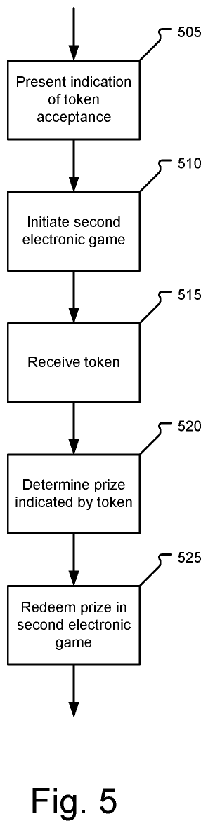

FIG. 5 is a flowchart illustrating an exemplary process for operating an electronic game according to another embodiment of the present disclosure. As illustrated in this example, operating an electronic game, i.e., a promoted electronic game, can comprise presenting 505 an indication of token acceptance, e.g., displaying an icon, message, or other feature on an interface of the second, promoted electronic game. The second electronic game can be initiated 510 on the second gaming system 110 and the token provided to the player of the first electronic game can be received 515 from the player. Receiving 515 the token provided to the player of the first electronic game can comprise reading a ticket, reading an electronic record associated with the player of the first electronic game, or receiving the token from a mobile device of the player of the first electronic game. The prize indicated by the received token can be determined 520 and the determined prize can be redeemed 525 in the second electronic game. For example, the determined prize in the second electronic game can be based on an amount of time the first electronic game was played or an amount of wagers made in the first electronic game. The redeemed prize in the second electronic game can comprise a credit, a bonus, a session boost, a discount on wagers, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for operating an electronic game, the method comprising:
executing, by a processor of a first gaming system, a first electronic game on the first gaming system;
monitoring, by the processor of the first gaming system, game play information related to the execution of the first electronic game;
detecting, by the processor of the first gaming system, a termination of the first electronic game on the first gaming system;
generating, by the processor of the first gaming system, a token based on the monitored game play information related to execution of the first electronic game, the token indicating a prize redeemable in a second electronic game; and
providing, by the processor of the first gaming system, the generated token to a player of the first electronic game.

2. The method of claim 1, further comprising:
presenting, by a processor of a second gaming system, an indication of token acceptance in a second electronic game available on the second gaming system;
initiating, by the processor of the second gaming system, the second electronic game on the second gaming system;
receiving, by the processor of the second gaming system, the token provided to the player of the first electronic game;
determining, by the processor of the second gaming system, the prize indicated by the received token; and
redeeming, by the processor of the second gaming system, the determined prize in the second electronic game.

3. The method of claim 1, wherein the prize redeemable in the second electronic game is determined based on an amount of time the first electronic game was played.

4. The method of claim 1, wherein the prize redeemable in the second electronic game is determined based on an amount of wagers made in the first electronic game.

5. The method of claim 1, wherein providing the generated token to the player of the first electronic game comprises printing a ticket.

6. The method of claim 1, wherein providing the generated token to the player of the first electronic game comprises updating an electronic record associated with the player of the first electronic game.

7. The method of claim 1, wherein providing the generated token to the player of the first electronic game comprises transferring the token to a mobile device of the player of the first electronic game.

8. A system comprising:
a first gaming system comprising a processor and a memory coupled with and readable by the processor and having stored therein a set of instructions which, when executed by the processor, causes the processor to:
execute a first electronic game on the first gaming system,
monitor game play information related to the execution of the first electronic game,
detect a termination of the first electronic game on the first gaming system,
generate a token based on the monitored game play information related to execution of the first electronic game, the token indicating a prize redeemable in a second electronic game, and
provide the generated token to a player of the first electronic game; and
a second gaming system comprising a processor and a memory coupled with and readable by the processor and having stored therein a set of instructions which, when executed by the processor, causes the processor to:
present an indication of token acceptance in a second electronic game available on the second gaming system,
initiate the second electronic game on the second gaming system,
receive the token provided to the player of the first electronic game,
determine the prize indicated by the received token, and
redeem the determined prize in the second electronic game.

9. The system of claim 8, wherein receiving the token provided to the player of the first electronic game comprises reading a ticket.

10. The system of claim 8, wherein receiving the token provided to the player of the first electronic game comprises reading an electronic record associated with the player of the first electronic game.

11. The system of claim 8, wherein receiving the token provided to the player of the first electronic game comprises receiving the token from a mobile device of the player of the first electronic game.

12. The system of claim 8, wherein presenting the indication of token acceptance in the second electronic game available on the second gaming system comprises displaying, on a display device of the second gaming system, a promo code bug.

13. The system of claim 8, wherein the determined prize in the second electronic game is based on an amount of time the first electronic game was played.

14. The system of claim 8, wherein the determined prize in the second electronic game is based on an amount of wagers made in the first electronic game.

15. A non-transitory, computer-readable medium comprising a set of instructions stored therein which when executed by a processor, causes the processor to:
execute a first electronic game on the first gaming system;
monitor game play information related to the execution of the first electronic game;
detect a termination of the first electronic game on the first gaming system;
generate a token based on the monitored game play information related to execution of the first electronic game, the token indicating a prize redeemable in a second electronic game; and
provide the generated token to a player of the first electronic game.

16. The non-transitory, computer-readable medium of claim 15, wherein the instructions further cause the processor to:
present an indication of token acceptance in a second electronic game available on the second gaming system;
initiate the second electronic game on the second gaming system;
receive the token provided to the player of the first electronic game;
determine the prize indicated by the received token; and
redeem the determined prize in the second electronic game.

17. The non-transitory, computer-readable medium of claim 16, wherein the redeemed prize in the second electronic game comprises a credit.

18. The non-transitory, computer-readable medium of claim 16, wherein the redeemed prize in the second electronic game comprises a bonus.

19. The non-transitory, computer-readable medium of claim 16, wherein the redeemed prize in the second electronic game comprises a session boost.

20. The non-transitory, computer-readable medium of claim 16, wherein the redeemed prize in the second electronic game comprises a discount on wagers.
